(19) United States
(12) Patent Application Publication
(10) Pub. No.: US 2024/0258756 A1
(43) Pub. Date: Aug. 1, 2024

(54) SYSTEM FOR ACTIVELY CONTROLLING A CAVITY LENGTH OF AN OPTICAL ASSEMBLY

(71) Applicant: CYMER, LLC, San Diego, CA (US)

(72) Inventors: Saptaparna Das, San Diego, CA (US); Eric Anders Mason, San Diego, CA (US)

(21) Appl. No.: 18/564,335

(22) PCT Filed: May 6, 2022
(86) PCT No.: PCT/US2022/028188

§ 371 Date: Nov. 27, 2023

Related U.S. Application Data
(60) Provisional application No. 63/195,390, filed on Jun. 1, 2021.

(51) Int. Cl. H01S 3/00; G02B 17/00; G02B 26/00; H01S 3/225; H01S 3/23

(52) U.S. Cl. CPC H01S 3/0057; G02B 17/004; G02B 26/00; H01S 3/0071; H01S 3/225; H01S 3/2308

(57) ABSTRACT

A system includes: an optical pulse stretcher including: a first reflective optical element: a second reflective optical element; and an optical coupling system, where a distance between the first reflective optical element and the second reflective optical element defines a separation distance in an optical cavity, and the optical coupling system is configured to bring pulses of light into the cavity and to allow pulses of light to exit the cavity. The system also includes an actuation system configured to control the separation distance; a sensor configured to produce data related to at least two pulses of light that exit the cavity; and a control system coupled to the actuation system, where the control system is configured to control the actuation system and the separation distance based on the data.

### CROSS REFERENCE TO RELATED APPLICATIONS

This application claims priority to U.S. Application No. 63/195,390, filed Jun. 1, 2021, titled SYSTEM FOR ACTIVELY CONTROLLING A CAVITY LENGTH OF AN OPTICAL ASSEMBLY, which is incorporated herein in its entirety by reference.

### TECHNICAL FIELD

This disclosure relates to a system for actively controlling a cavity length of an optical assembly. The optical assembly may be, for example, a pulse stretcher used with a deep ultraviolet light (DUV) source.

### BACKGROUND

Photolithography is the process by which semiconductor circuitry is patterned on a substrate such as a silicon wafer. A photolithography optical source provides the deep ultraviolet (DUV) light used to expose a photoresist on the wafer. One type of gas discharge light source used in photolithography is known as an excimer light source or laser. An excimer light source typically uses a gas mixture that is a combination of one or more noble gases, such as argon, krypton, or xenon, and a reactive species such as fluorine or chlorine. The excimer light source derives its name from the fact that under the appropriate condition of electrical stimulation (energy supplied) and high pressure (of the gas mixture), a pseudo-molecule called an excimer is created, which only exists in an energized state and gives rise to amplified light in the ultraviolet range. An excimer light source produces a light beam that has a wavelength in the deep ultraviolet (DUV) range and this light beam is used to pattern semiconductor substrates (or wafers) in a photolithography apparatus. The excimer light source can be built using a single gas discharge chamber or using a plurality of gas discharge chambers. The gas mixture in the gas discharge chamber may be exhausted from the gas discharge chamber or chambers.

### SUMMARY

In one aspect, a system includes: an optical pulse stretcher including: a first reflective optical element; a second reflective optical element; and an optical coupling system, where a distance between the first reflective optical element and the second reflective optical element defines a separation distance in an optical cavity, and the optical coupling system is configured to bring pulses of light into the cavity and to allow pulses of light to exit the cavity. The system also includes an actuation system configured to control the separation distance; a sensor configured to produce data related to at least two pulses of light that exit the cavity; and a control system coupled to the actuation system, where the control system is configured to control the actuation system and the separation distance based on the data.

Implementations may include one or more of the following features. The control system may be further configured to: analyze additional data from the sensor after controlling the actuation system; and determine whether to control the actuation system again based on the analyzed additional data.

The control system may be configured to identify at least two pulses of light in the data, and to determine a position of the identified pulses of light in the data; and the control system may control the actuation system and the separation distance based on the determined positions.

The sensor may be a two-dimensional imaging sensor, and the data from the imaging sensor may include a two-dimensional image. In some implementations, determining a position of the identified pulses of light in the data includes determining a spatial separation between at least two pulses of light identified in the data, and the control system controls the actuation system and the separation distance based on the determined spatial separation. The control system may control the actuation system and the separation distance by moving one or more of the first reflective optical element and the second reflective optical element. The control system also may be configured to determine a direction to move the one or more of the first reflective optical element and the second reflective optical element based on the determined spatial separation. The control system also may be configured to determine an amount to move the one or more of the first reflective optical element and the second reflective optical element based on the determined spatial separation.

In some implementations, the determined spatial separation includes a first determined spatial separation, and the control system is further configured to: analyze additional data from the sensor after controlling the actuation system; identify at least one additional pulse of light in the additional data; determine a second spatial separation, the second spatial separation being a spatial separation between the at least one additional identified pulse of light and at least one other pulse of light; compare the first spatial separation and the second spatial separation; and determine whether to control the actuation system again based on the comparison. In some implementations, the control system only controls the actuation system again if the second spatial separation is a threshold value greater than the first spatial separation. The spatial separation may be between a center of each of at least two pulses of light identified in the data.

The first reflective optical element may include a first curved reflective surface; and the second reflective optical element may include a second curved reflective surface. The separation distance may be the distance between a center of the first curved reflective surface and a center of the second curved reflective surface.

The optical coupling system may include a beam splitter that is separate and distinct from the first reflective optical element and the second reflective optical element.

The actuation system may include: a first actuation module coupled to the first reflective optical element, the first activation module configured to move the first reflective optical element based on a command from the control system; and a second actuation module coupled to the second reflective optical element, the second activation module configured to move the second reflective optical element based on a command from the control system; and the control system may be configured to control the actuation system by commanding one or more of the first actuation module and the second actuation module.

The cavity may lack a gain medium.

In another aspect, a system includes an optical assembly that includes: a first optical element including a first curved optical surface; and a second optical element including a second curved optical surface, where the first curved optical and the second curved optical surface define at least a portion of an optical cavity. The system also includes a sensor configured to produce data related to at least two pulses of light that exit the cavity; and a control system configured to control a position of one or more of the first optical element and the second optical element based on data from the sensor to thereby compensate for changes in a radius of curvature of one or more of the first curved optical surface and the second curved optical surface.

Implementations include one or more of the following features.

The data may include information related to a location of at least two pulses of light that exit the cavity.

The data may include information related to a divergence of at least two pulses of light that exit the cavity.

The system also may include an actuation system coupled to one or more of the first optical element and the second optical element.

The first curved surface may have a first nominal radius of curvature, and the second curved surface may have a second nominal radius of curvature. The cavity may be a confocal cavity.

A distance between the first curved reflective surface and the second curved reflective surface may define a length of the cavity, and the control system may be configured to compensate for changes in the radius of curvature of one or more of the first curved optical surface and the second curved optical surface by adjusting the length of the cavity.

The optical assembly may include a pulse stretcher.

Pulses of light may exit the cavity through one of the first optical element and the second optical element.

Pulses of light may exit the cavity through an optical element that is separate and distinct from the first optical element and the second optical element.

In another aspect, a control system configured for use with an optical pulse stretcher includes a data analysis module configured to analyze data from a sensor. The sensor is configured to sense at least a portion of two or more pulses of light that exit an optical cavity at different times, and, to analyze the data, the data analysis module is configured to: determine one or more properties of at least two of the pulses of light based on the data from the sensor. The control system also includes an actuation control module configured to: determine a command signal for an actuation system coupled to the optical cavity based on the one or more properties; and provide the command signal to the actuation system to adjust a length of the optical cavity.

Implementations may include one or more of the following features.

The determined one or more properties may include a location of each of the at least two pulses of light in a plane perpendicular to a direction of propagation of the pulse of light. The determined one or more properties may include a divergence of each of the at least two pulses of light in a plane perpendicular to a direction of propagation of the pulse of light.

In another aspect, an optical system includes: an optical oscillator configured to emit an amplified pulsed light beam on a beam path; and a pulse stretcher configured to be placed on the beam path, the pulse stretcher including: a first optical element including a first curved optical surface; and a second optical element including a second curved optical surface. The first curved optical surface and the second curved optical surface define a cavity. The optical system also includes: a sensor configured to produce data related to at least two pulses of the amplified pulsed light beam that exit the cavity; and a control system configured to control a position of one or more of the first optical element and the second optical element based on data from the sensor to thereby compensate for changes in a radius of curvature of one or more of the first curved optical surface and the second curved optical surface.

In some implementations, the optical oscillator is a deep ultraviolet (DUV) optical oscillator that is configured to emit an amplified light beam having one or more DUV wavelengths.

Implementations of any of the techniques described above and herein may include a process, an apparatus, and/or a method. The details of one or more implementations are set forth in the accompanying drawings and the description below. Other features will be apparent from the description and drawings, and from the claims.

### BRIEF DESCRIPTION OF THE DRAWINGS

FIG. 1A is a block diagram of an example of a system.

FIG. 1B is an example of two-dimensional data.

FIG. 2A is a block diagram of another example of a system.

FIGS. 2B-2D are examples of two-dimensional data.

FIG. 3 is a block diagram of another example of a system.

FIG. 4 is a flow chart of an example of a process.

FIG. 5 is a block diagram of an example of a photolithography system.

### DETAILED DESCRIPTION

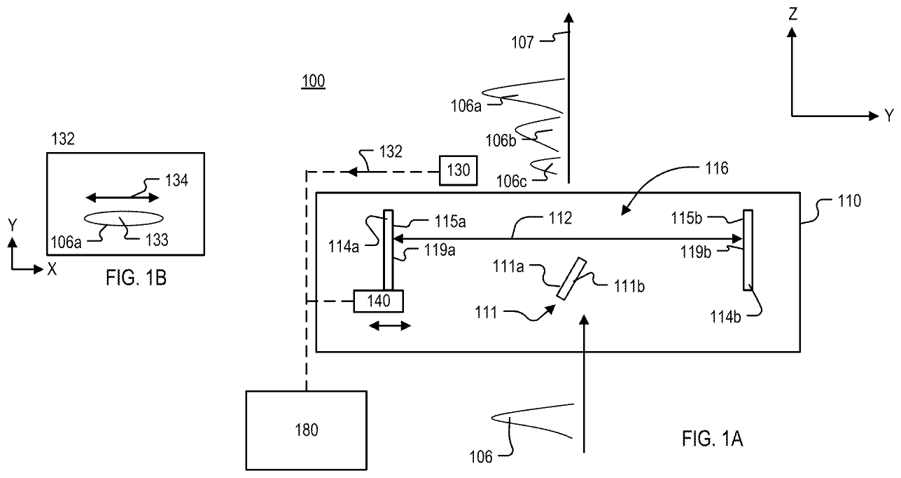

FIG. 1A is a block diagram of a system 100 that includes a pulse stretcher 110, a sensor 130, and a control system 180. The control system 180 uses data 132 from the sensor 130 to adjust a cavity length 112 of the pulse stretcher 110 during use of the pulse stretcher 110. Intentionally adjusting the cavity length 112 compensates for thermal effects and other variations that may occur during use of the pulse stretcher 110.

The pulse stretcher 110 includes an optical coupling system 111, a first optical element 114a, and a second optical element 114b. In the example of FIG. 1A, the first optical element 114a and the second optical element 114b have respective reflective surfaces 115a and 115b. The reflective surfaces 115a and 115b face each other and define an optical cavity 116 in the space between the surfaces 115a and 115b. Light propagates in the optical cavity 116. The optical cavity 116 does not include a gain medium. The reflective surfaces 115a and 115b are separated from each other by the cavity length 112. The cavity length 112 may be the distance between a center point 119a of the first reflective surface 115a and a center point 119b of the second reflective surface 115b.

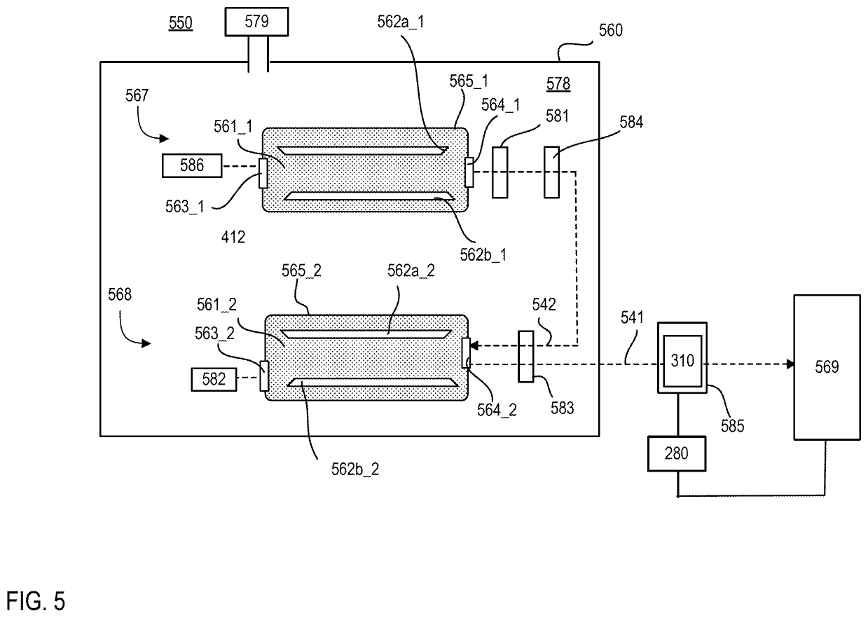

In operational use, a pulse 106 of light enters the optical cavity 116 by interacting with the optical coupling system 111. In the example shown, the optical coupling system 111 includes a reflective surface on a first side 111a and a reflective surface on a second side 111b of a substrate or material. The reflective surfaces on the sides 111a and 111b may be partially reflective to the wavelengths in the pulse 106. In other words, a portion of the pulse 106 may pass through the optical coupling system 111. The sides 111a and 111b are opposite sides of the optical coupling system 111. The pulse 106 reflects off of the side 111b toward the second reflective surface 115b. The pulse 106 then reflects off of the second reflective surface 115b, propagates in the cavity 116, and reflects off of the first reflective surface 115a. After reflecting off the first reflective surface 115a, a portion of the light in the pulse 106 interacts with the reflective surface on the first side 111a of the optical coupling system 111 and is reflected out of the cavity 116 as a first daughter pulse 106a. The first daughter pulse 106a propagates generally along the Z direction. The remaining light in the pulse 106 continues to propagate in the cavity 116 and is reflected from the reflective surfaces 115a and 115b until being reflected out of the cavity as subsequent daughter pulses. The example of FIG. 1A shows three daughter pulses 106a, 106b, and 106c. Many more daughter pulses may be created, but only three are shown. The daughter pulses 106b and 106c exit the cavity 116 after the daughter pulse 106a, and the daughter pulses 106b and 106c have a lower optical intensity than the daughter pulse 106a. The daughter pulses 106a-106c are used in an end-user's application or provided to an apparatus that acts on the daughter pulses 106a-106c. For example, the daughter pulses 106a-106c may be provided to the lithography exposure apparatus 569 show in in FIG. 5.

The sensor 130 measures information about the pulses that exit the cavity 116 (such as the daughter pulses 106a, 106b, and 106c) and provides the information to the control system 180 as data 132. The data 132 may include, for example, an indication of the divergence of the daughter pulses, images of the daughter pulses, an indication of a time between daughter pulses, an indication of a temporal duration of the daughter pulses, and/or information related to intensity of the daughter pulses. FIG. 1B shows an example in which the data 132 is a two-dimensional image of the daughter pulse 106a in an X-Y plane downstream (in the Z direction) relative to the optical coupling system 111. The X-Y plane is generally perpendicular to the direction of propagation of the pulse 106a. The daughter pulse 106a has a horizontal divergence 134 and a pointing 133. The horizontal divergence 134 is the width of the pulse 106a along a direction that is perpendicular to the direction of propagation (in this example, the divergence 134 is along the Y axis). The horizontal divergence 134 may be the width (for example, the full width half max (FWHM)) of the pulse 106a. The pointing 133 is the location of the pulse 106a in the X-Y plane. For example, the pointing 133 may be the location of the spatial center of the pulse 106a or the location of the spatial center of the FWHM of the pulse 106a.

The control system 180 uses the data 132 to adjust the cavity length 112 by controlling an actuator 140. In the example of FIG. 1A, the actuator 140 is coupled to the optical element 114a. Controlling the actuator 140 causes the reflective surface 115a to move toward or away from the reflective surface 115b, thereby decreasing or increasing, respectively, the cavity length 112.

The control system 180 allows the cavity length 112 to be adjusted during use of the cavity 116. As compared to a traditional approach in which the cavity length 112 is set at the time of manufacture or at installation, or an approach in which the cavity length 112 is only able to be adjusted manually during a service event when no light propagates in the cavity 116, adjusting the cavity length 112 during use improves the performance of the pulse stretcher 110 and reduces downtime for the system 100. Repeated interaction with pulses of light heats the reflective surfaces 115a and 115b, and these thermal effects change the radius of curvature of the reflective surfaces 115a and 115b. The changes in the radius of curvature caused by the thermal effects also change the pointing 133 and/or the horizontal divergence 134 of the daughter pulses that exit the cavity 116.

It is desirable to maintain a constant pointing and divergence among the daughter pulses that exit the cavity 116. For example, as discussed above, the daughter pulses are provided to a separate device or to the end user's application. If the pointing 133 and/or the divergence 134 of the daughter pulses changes over time, the separate device and/or application does not receive the full amount of light expected. This may lead to poor results or failure. Adjusting the cavity length 112 during use of the pulse stretcher 110 results in the pointing 133 and divergence 134 remaining constant among the daughter pulses that exit the cavity 116. Thus, by adjusting the cavity length 112 during operational use, the control system 180 improves the performance of the pulse stretcher 110.

Furthermore, due to variations in manufacturing and/or installation, the thermal effects that the reflective surface 115a experiences may be different than the thermal effects experienced by the reflective surface 115b, and the reflective surfaces 115a and/or 115b may experience different amounts of thermal effects than reflective surfaces in other pulse stretchers. Moreover, different end users operate the pulse stretcher 110 differently based on the needs of their application, and the needs of a particular end user's application may change between service events. For example, some end users may pass pulses of higher intensity and/or higher repetition rates through the pulse stretcher 110, or a user may vary such properties rapidly while using a particular pulse stretcher 110. A higher repetition rate (for example, greater than 500 Hertz) causes more thermal effects and a greater need for cavity length adjustment than a lower repetition rate. These operational differences also change the amount of thermal heating that occurs in the pulse stretcher 110. By adjusting the cavity length 112 during use based on the data 132, the control system 180 accounts for these variations such that the control system 180 may be used with a variety of pulse stretchers. Finally, the active adjustment of the cavity length 112 is more actuate and quicker than a manual adjustment done during servicing of the pulse stretcher 110, and the active adjustment performed by the control system 180 is performed more often and is thus more stable.

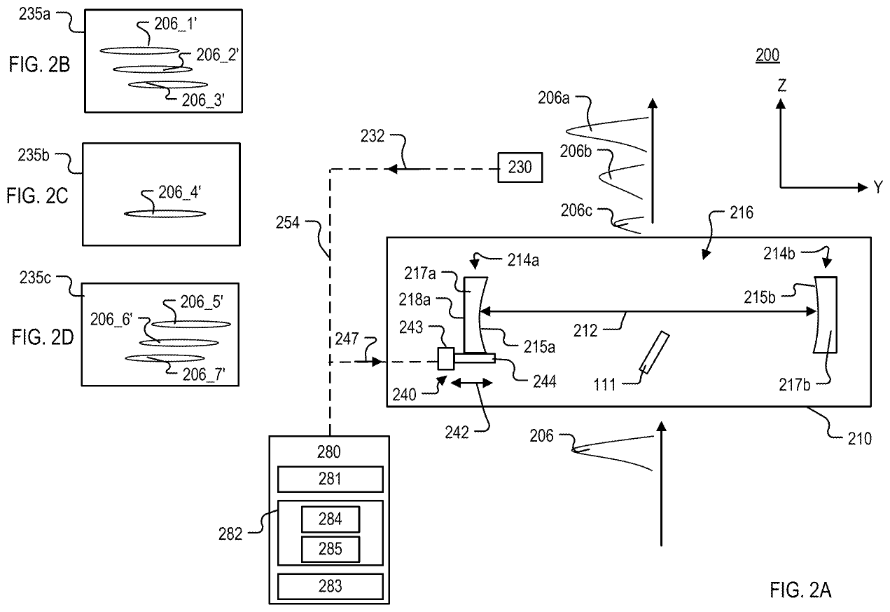

FIG. 2A is a block diagram of a system 200. The system 200 includes a pulse stretcher 210 and a control system 280. The pulse stretcher 210 has a confocal geometry. In one example, a cavity with a confocal geometry (such as the pulse stretcher 210) is formed by two curved reflective surfaces that each have a radius of curvature that is equal to the distance between the curved reflective surfaces. In other examples, a cavity with confocal geometry may include two or more mirrors that focus a beam of circulating light to at least one focal point at a fixed location during each round trip within the cavity.

The pulse stretcher 210 includes optical elements 214a and 214b. The optical element 214a includes a substrate 217a and a curved reflective surface 215a on the substrate 217a. The optical element 214b includes a substrate 217b and a curved reflective surface 215b on the substrate 217b. The reflective surfaces 215a and 215b are optically reflective coatings or films that are formed on the respective substrate 217a and 217b. The reflective surfaces 215a and 215b define a cavity 216, which is between the reflective surfaces 215a and 215b and has a cavity length 212.

The reflective surface 215a has a radius of curvature R1, and the reflective surface 215b has a radius of curvature R2. The values of R1 and R2 are nominally the same, and the cavity length 212 is also nominally equal to the values of R1 and R2. During use of the pulse stretcher 210, the radius of curvature R1 may deviate from the nominal value due to stress induced on the reflective surface 215a and/or the radius of curvature R2 may change due to stress induced on the reflective surface 215b. For example, according to Equation (1), which is Stoney's equation:

$$ROC = \frac{{σ}_{f} 6 ( 1 - {v}_{s} ) t}{{E}_{s} {d}^{2}} , \qquad Equation ( 1 )$$

where
ROC is the radius of curvature, σ_{f} is the film stress, vₛ is Poisson's ratio for the substrate, Es is Young's modulus of the substrate, t is the thickness of the film, and d is the thickness of the substrate. To determine the actual radius of curvature for the reflective surface 215a using Equation 1, σ_{f} is the stress on the reflective surface 215a, vₛ is Poisson's ratio for the substrate 217a, t is the thickness of the reflective surface 215a, and d is the thickness of the substrate 217c.

Under operational conditions, the stress (of) on the reflective surface 215a may be between 100 and 500 megaPascals (MPa), Poisson's radio may be between 0.1 and 0.3, Young's modulus (Es) may be between 70 and 80 gigaPascals (GPa), and the actual radius of curvature for the reflective surface 215a may increase by about 30 to 170 micrometers (μm) as compared to the nominal R1 value. For a pulse with a wavelength of 193 nanometers (nm), a 170 μm change in the radius of curvature on the reflective surface 215a and 215b may lead to an increase of about 0.068 milliradian (mrad) in the divergence of daughter pulses 206a-206c. Changes in the radius of curvature R1 and/or R2 also change the pointing of pulses that exit the pulse stretcher 210 (such as daughter pulses 206a-206c).

The control system 280 adjusts the cavity length 212 based on data 232 from a sensor 230 to compensate for changes in R1 and/or R2 that may occur during use of the pulse stretcher 210. The sensor 230 may be, for example, a camera or a two-dimensional array of photodiodes sensitive to the wavelengths in the daughter pulses. Referring also to FIGS. 2B-2D, the sensor 230 produces the data 232, which in this example includes two-dimensional images 235a (FIG. 2B), 235b (FIG. 2C), and 235c (FIG. 2D). The data 232 are two-dimensional images of daughter pulses in an X-Y plane downstream (in the Z direction) relative to the optical coupling system 111. The X-Y plane is generally perpendicular to the direction of propagation of the daughter pulses. The data 232 provides information related to properties of the daughter beam that change when the radius of curvature of the reflective surfaces 215a and/or 215b change.

Each image 235a, 235b, 235c includes a representation of plurality of daughter pulses that exit the cavity 216 over a time period. Each image 235a, 235b, 235c may be a composite or combined image based on images that include a representation of only one daughter pulse. In some implementations, each image 235a, 235b, 235c is a collection of individual images that each include a representation of one daughter pulse.

The image 235a includes representations of daughter pulses 206_1′, 206_2′, and 206_3′. The daughter pulses 206_1′, 206_2′, 206_3′ are any daughter pulses that exit the cavity 216. For example, the daughter pulses 206_1′, 206_2′, 206_3′ may be images of the daughter pulses 206a, 206b, 206c. In another example, the daughter pulses 206_1′, 206_2′, and 206_3′ are images of daughter pulses that each arise from a separate original pulse. For example, the daughter pulses 206_2′ and 206_3′ may arise from original pulses that are 100s of pulses after the pulse 206. Regardless of the form of the image 235a, the image 235a includes representations of different daughter pulses that exit the cavity 216 over time. The properties of the representations indicate whether or not the cavity length 212 should be adjusted. For example, in the image 235a, the pointing of the daughter pulses 206a, 206b, and 206c is not constant, indicating that the cavity length 212 is changing due to thermal effects on the reflective surface 215a or 215b.

The images 235b and 235c also include representations of daughter pulses that exit the cavity 216. The image 235b includes a single representation 206_4′. In the image 235b, the daughter pulses have a consistent pointing and horizontal divergence and are thus aligned with each other are in the same location of the image 235b and this shows up as the single representation 206_4′. This indicates that the cavity length 212 is not changing due to thermal effects. The image 235c includes representations 206_5′, 206_6′, and 206_7′. Each representation 206_5′, 206_6′, and 206_7′ is in a different location of the image 235b, indicating that the radius of curvature of the reflective surface 215a and/or 215b is changing due to thermal effects and the cavity length 212 should be adjusted.

Other forms of the data 232 are possible. For example, in some implementations, the sensor 230 is a one-dimensional sensor, such as a photodiode. In these implementations, the data 232 is a representation of the amount of light at a fixed point in space at a particular time. Regardless of the form of the data 232, the data 232 includes information that indicates or represents a property that is affected by changes to the radius of curvature of the reflective surface 215a and/or 215b, such as the pointing and/or divergence of the daughter pulses. By analyzing the properties of the various daughter pulses, the control system 280 determines whether and how to adjust the cavity length 216.

The control system 280 includes an electronic processing module 281, an electronic storage 282, and an I/O interface 283. The electronic processing module 281 includes one or more processors suitable for the execution of a computer program such as a general or special purpose microprocessor, and any one or more processors of any kind of digital computer. Generally, an electronic processor receives instructions and data from a read-only memory, a random access memory (RAM), or both. The electronic processing module 281 may include any type of electronic processor. The electronic processor or processors of the electronic processing module 281 execute instructions and access data stored on the electronic storage 282. The electronic processor or processors are also capable of writing data to the electronic storage 282.

The electronic storage 282 may be volatile memory, such as RAM, or non-volatile memory. In some implementations, and the electronic storage 282 includes non-volatile and volatile portions or components. The electronic storage 282 stores data and information that is used in the operation of the control system 280. For example, the electronic storage 282 may store specification information that specifies a range of acceptable values for the divergence and/or the pointing of the daughter pulses. The range of acceptable values may be stored in association with various operating conditions, such as pulse repetition rate or pressure of the cavity 216. The range of acceptable values may be different for different operating conditions. The electronic storage 282 may store additional specifications and metrics. For example, the electronic storage 282 may store values or rules that represent the maximum acceptable difference in divergence or pointing between two daughter pulses.

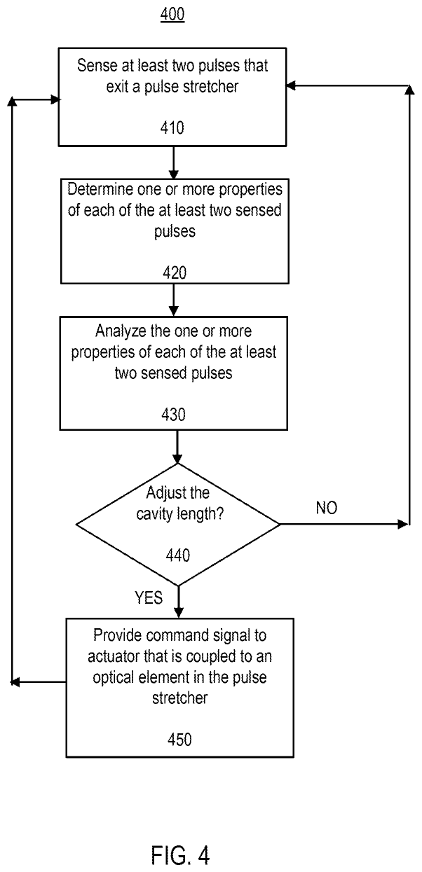

The electronic storage 282 also stores machine-executable instructions (for example, in the form of a computer program) that define a data analysis module 284 and an actuation control module 285. The data analysis module 284 processes the data 232 and produces an indication of whether the cavity length 216 should be adjusted. In some implementations, the data analysis module 284 implements the process 400 shown in FIG. 4.

The actuation control module 285 provides a control signal 247 to the actuator 240. The control signal 247 causes the actuator 240 to adjust the cavity length 216 as specified by the indication produced by the data analysis module 284. The form of the control signal 247 depends on the characteristics of the actuator 240. For example, the control signal 247 may be a voltage signal that is applied to a portion of the actuator 240 or a signal that controls a motor interface. The actuator 240 is coupled to the optical element 214a and is capable of causing the optical element 214a to move along a path 242. The path 242 is a linear path and is along the Y axis in the example of FIG. 2A. Moving the optical element 214a in the +Y direction decreases the cavity length 212. Moving the optical element 214a in the −Y direction increases the cavity length 212.

The actuator 240 is any type of device that is capable of moving the optical element 214a. In the example shown in FIG. 2A, the actuator 240 includes a controllable element 243 that is attached to a platform 244. The optical element 215a is attached to the platform 244. The platform 244 may be, for example, a plate or stage. The controllable element 243 is any type of device that is capable of actuation by the actuation control module 285. For example, the controllable element 243 may be a linear motor with an output that mechanically coupled to the platform 244. In this implementation, the actuation control module 243 controls the motor to move the platform 244 along the path 242. In another example, the controllable element 243 is a piezoelectric structure that expands or contracts along the path 242 in response to an applied voltage signal. In these implementations, the actuation control module 285 controls a voltage source (not shown) to apply a voltage having a particular magnitude and polarity such that the piezoelectric structure expands or contracts along the path 242.

The electronic storage 282 also may store machine-executable instructions that cause the control system 280 to interact with other components and subsystems in the system 200. For example, the electronic storage 282 may store instructions that cause the I/O interface to display or generate an alarm or perceivable alert when the divergence and/or pointing of the daughter pulses is outside of the range of acceptable values.

The I/O interface 283 is any kind of interface that allows the control system 280 to exchange data and signals with an operator, the sensor 230, the actuator 240, and/or an automated process running on another electronic device. For example, in implementations in which rules, specifications, or instructions stored on the electronic storage 282 may be edited, the edits may be made through the I/O interface 283. The I/O interface 283 may include one or more of a visual display, a keyboard, and a communications interface, such as a parallel port, a Universal Serial Bus (USB) connection, and/or any type of network interface, such as, for example, Ethernet. The I/O interface 283 also may allow communication without physical contact through, for example, an IEEE 802.11, Bluetooth, or a near-field communication (NFC) connection.

The control system 280 is coupled to the sensor 230 and the actuator 240 through a data connection 254. The data connection 254 may be a physical cable or other physical data conduit (such as a cable that supports transmission of data based IEEE 802.3), a wireless data connection (such as a data connection that provides data via IEEE 802.11 or Bluetooth), or a combination of wired and wireless data connections. The data and information that is provided over the data connection may be set through any type of protocol or format. The data connection 254 is connected to the sensor 230 and the actuator 240 at communication interfaces that are part of the sensor 230 and the actuator 240, respectively. The communication interfaces may be any kind of interface capable of sending and receiving data. For example, the data interfaces may be any of an Ethernet interface, a serial port, a parallel port, or a USB connection. In some implementations, the data interfaces allow data communication through a wireless data connection. For example, each data interface may be an IEEE 811.11 transceiver, Bluetooth, or an NFC connection.

Other implementations of the system 200 are possible. For example, the actuator 240 may be implemented without the platform 244. In these implementations, the controllable element 243 is directly coupled to the optical element 214a. For example, the controllable element 243 may be a piezoelectric structure that is directly mounted to the center of a side 218a of the optical element 214a. Moreover, an actuator may be mounted to the optical element 214b in addition to or instead of being mounted to the optical element 214a. In implementations in which the actuator 240 is mounted to the optical element 214a and another actuator is mounted to the optical element 214b, the actuator 240 and the other actuator may be identical devices that are controlled by the actuation control module 285.

In the examples of FIGS. 1A and 2A, a cavity length represents a geometry or a placement of two reflective surfaces. In other examples, a cavity length may represent the length of a round-trip optical path in an optical cavity, or a portion of the length of a round-trip optical path in an optical cavity.

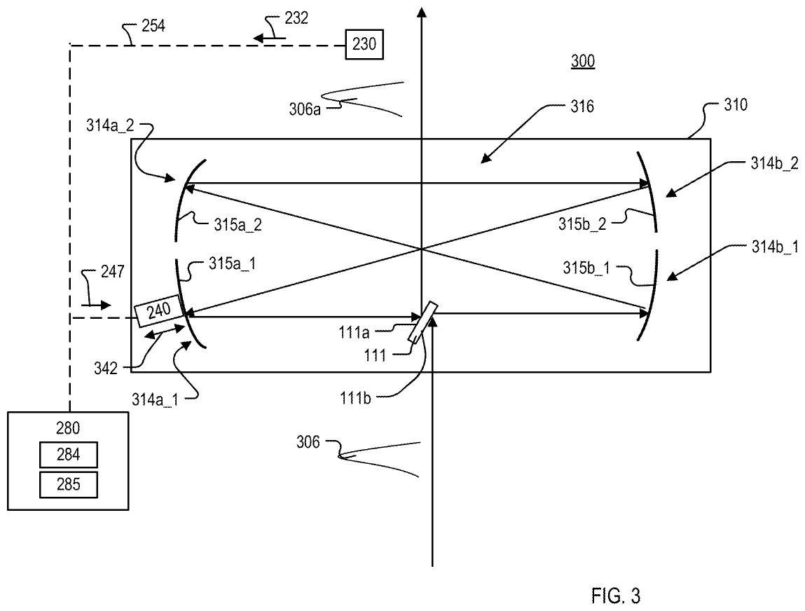

FIG. 3 is a block diagram of a system 300 that includes another example of a pulse stretcher 310. The pulse stretcher 310 is similar to the pulse stretcher 210 (FIG. 2A), except the pulse stretcher 310 includes four optical elements 314a_1, 314a_2, 314b_1, 314b_2 that include respective curved reflective surfaces 315a_1, 315a_2, 315b_1, 315b_2.

The nominal radius of curvature for the reflective surfaces 315a_1, 315a_2, 315b_1, 315b_2 are Ra_1, Ra_2, R_1, R_2 respectively. The curved reflective surfaces 315a_1, 315a_2, 315b_1, 315b_2 define a cavity 316 that has a confocal geometry. That is, each of the curved reflective surfaces 315a_1, 315a_2, 315b_1, 315b_2 is separated from the preceding reflective surface by a distance that is equal to the radius of curvature of the preceding reflective surface.

In operational use, a pulse of light 306 enters the cavity 316 by reflecting from the side 111b of the optical coupling system 111 and propagating to the reflective surface 315b_1. The pulse 306 is reflected from the reflective surface 315b_1 to the reflective surface 315a_2, then to the reflective surface 315b_2, and then to the reflective surface 315a_1. After reflecting from the reflective surface 315a_1, a portion of the pulse 306 interacts with the side 111a of the optical coupling element 111 and exits the cavity 316 as a daughter pulse 306a. In the configuration shown in FIG. 3, the reflective surface 315b_1 precedes the reflective surface 315a_2, the reflective surface 315a_2 precedes the reflective surface 315b_2, and the reflective surface 315b_2 precedes the reflective surface 315a_1.

The pulse stretcher 310 is initially configured with the reflective surface 315a_2 separated from the reflective surface 315b_1 by a distance equal to R_1, the reflective surface 315b_2 separated from the reflective surface 315a_2 by a distance equal to Ra_2, and the reflective surface 315a_1 separated from the reflective surface 315b_2 by a distance equal to R_2. However, during use of the pulse stretcher 310, the radius of curvature of the various reflective surfaces 315a_1, 315a_2, 315b_1, 315b_2 may change due to thermal stress. The changes in the radius of curvature changes the path length that a pulse travels in the pulse stretcher, thereby changing the pointing and horizontal divergence of pulses that exit the pulse stretcher 310.

To account for changes in the radius of curvature, the system 300 includes the sensor 230 and the control system 280. The sensor 230 measures one or more properties of at least two daughter pulses that exit the cavity 316 and provides the data 232 to the control system 280. As discussed above, the data analysis module 284 analyzes the data and determines whether to adjust the length of the cavity 316 by controlling the actuator 240. For example, if the horizontal divergence is not constant between two pulses that exit the cavity 316 or if the horizontal divergence is outside of a range of acceptable values, the control system 280 controls the actuator 240 to adjust the length of the cavity 316.

In the example shown in FIG. 3, the actuator 240 is mounted to the optical element 314a_1. To adjust the length of the cavity 316, the actuation control module 285 controls the actuator 240 to move along a linear path 342 toward or away from the optical element 314b_2. Other implementations are possible. For example, the actuator 240 may be coupled to any of the optical elements 314a_2, 314b_1, or 314b_2. Moreover, the system 300 may include more than one instance of the actuator 240, each of which is coupled to a different optical element. In these implementations, the control system 280 controls all of the instances of the actuator 240 and may control each instance of the actuator separately. For example, the control system 280 may cause only some of the optical elements 314a_1, 314a_2, 314b_1, and 314b_2 to move even in implementations in which each of the optical elements 314a_1, 314a_2, 314b_1, and 314b_2 is coupled to an instance of the actuator 240.

FIG. 4 is a flow chart of an example process 400. The example process 400 is used to adjust a cavity length of a pulse stretcher while the pulse stretcher is in use. In other words, the process 400 is used while light propagates in the pulse stretcher. Thus, there is no need to take the pulse stretcher out of service to perform the process 400. The process 400 may be performed by the control system 180 or the control system 280. The process 400 is discussed with respect to the pulse stretcher 210 (FIG. 2A) and the control system 280, but the process 400 may be performed with other pulse stretchers, such as the pulse stretcher 110 (FIG. 1A) or the pulse stretcher 310 (FIG. 3).

At least two pulses that exit the cavity 216 are sensed by the sensor 230 (410). For example, the pulses 206a, 206b, and 206c may be sensed by the sensor 230. In another example, the pulse 206a and a daughter pulse that arises from a pulse that enters the cavity 216 after the pulse 206 are sensed by the sensor 230.

The sensor 230 provides the data 232 to the control system 280. The data 232 includes information related to a pointing or positioning of the sensed daughter pulses in the X-Y plane, which is perpendicular to the direction of propagation of the daughter pulses, and/or information related to the horizontal divergence (the extent of the sensed daughter pulses along the Y axis in FIG. 2A). The data 232 may be, for example, the images 235a, 235b, 235c shown in FIGS. 2B, 2C, and 2D, respectively.

One or more properties of each of at least two pulses sensed by the sensor 230 are determined (420). The data 232 is accessed by the data analysis module 284, and the data analysis module 284 determines the one or more properties. The properties are properties that relate to characteristics of the daughter pulses that indicate that the radius of curvature of the reflective surface 215a and/or 215b is changing over time. The data 232 is processed to determine the properties. For example, if the data 232 includes the image 235a, an edge detector or other filter is applied to the representations 206_1′, 206_2′, 206_3′ to extract the representations from the rest of the image 235a. The extracted representations are then analyzed to determine the properties. For example, in some implementations, the data analysis module 284 is configured to determine a spatial center of each extracted representation to determine an estimate of the pointing of each daughter pulse. In other implementations, the data analysis module 284 is configured to determine a width of each extracted representation along the Y axis to determine an estimate of the horizontal divergence of each daughter pulse.

The one or more properties of at least two daughter pulses are analyzed (430). For example, the properties of one daughter pulse are compared to the properties of another daughter pulse to determine whether the properties of the daughter pulses are changing over time. The properties are used to derive a cavity stability metric. To provide a specific example, the estimated pointing determined from the representation 206_1′ is compared to the estimated pointing determined from the representations 206_2′ and 206_3′. The differences between the pointing values are determined as a cavity stability metric and are compared to an acceptable range of differences in pointing values. The difference in pointing is a measure of the spatial separation of the daughter pulses at a particular X-Y plane.

The acceptable range of differences in pointing values is stored on the electronic storage 281 and may be programed or edited by an end-user via the I/O interface 283. The acceptable range of values may include positive and negative numbers. In some implementations, the acceptable range of pointing values includes only zero, indicating that no variation in pointing among the daughter pulses is considered acceptable.

Similarly, other properties, such as horizontal divergence, may be used in the analysis as the cavity stability metric. In implementations that analyze horizontal divergence, the estimated horizontal divergence of at least two daughter pulses is compared to determine a difference in divergence. The difference in divergence is compared to a range of acceptable values.

Other implementations are possible. For example, in some implementations, the differences in the properties of a plurality of daughter are tested with a rule instead of being compared to a range of acceptable values. The rule may indicate that if a property of one daughter pulse has a different value than the same property of another daughter pulse, the cavity length 212 should be adjusted.

Whether or not to adjust the cavity length is determined (440). The determination of whether or not to adjust the cavity length 212 is made based on the analysis in (430). For example, in implementations that use the differences in pointing as the cavity stability metric, the differences in pointing are compared to an acceptable range of values or to a test.

If the differences are within the acceptable range of values or if the differences satisfy the test, the process 400 returns to (410). If the differences are outside of the acceptable range or values or if the differences do not satisfy the test, the cavity length 212 is adjusted and the process proceeds to provide a command signal to the actuator 240 (450). The command signal is any type of signal that causes the actuator 240 to move the optical element 214a by a commanded amount. For example, in implementations in which the actuator 240 includes a piezoelectric device, the command signal is a voltage signal that is applied to the piezoelectric device. The magnitude and polarity of the voltage signal is determined from the analysis in (430). A larger magnitude in the difference between pointing values indicates that the adjustment to the cavity length 212 should also be larger than it would be for a smaller difference between pointing values. In this example, the magnitude of the voltage signal is larger such that the piezoelectric device moves the optical element 214a through a sufficient distance to account for the unintentional changes to the radius of curvature R1 and/or R2 caused by the thermal effects.

The process 400 returns to (410) after adjusting the cavity length 212 and continues to monitor pulses that exit the pulse stretcher 210. For example, in some implementations at least one additional daughter pulse is identified in the data, and the properties of that additional pulse are compared to the same properties of an earlier-occurring daughter pulse. The property may be a pointing or a spatial location, and the comparison produces a measure of the spatial separation between the earlier daughter pulse and the later daughter pulse at a particular X-Y plane. In these implementations, the control system 280 will continue to adjust the cavity length 212 until the spatial separation between two daughter pulses is less than a threshold value. For example, the control system 280 may be configured to continue to process the data 232 until the spatial separation between two daughter pulses is less than 0.01 mrad. Furthermore, the control system 280 may be configured to continue monitoring the data 232 and performing the process 400 even after the spatial threshold (or other property threshold) is reached.

Referring to FIG. 5, a block diagram of a photolithography system 550 is shown. The system 550 includes a DUV light source 560. The system 550 also includes the pulse stretcher 310 and the control system 280. The pulse stretcher 310 may be oriented in a horizontal configuration relative to the local gravity vector or in a vertical orientation relative to the local gravity vector. The orientation (horizontal or vertical) of the pulse stretcher 310 is determined by the application, and the orientation that results in the most efficient configuration and results in the least beam direction changes is used.

The light source 560 produces a pulsed light beam 541, which is provided to the pulse stretcher 310. The daughter pulses produced by the pulse stretcher 310 are provided to a lithography exposure apparatus 569. The light source 560 is a two-stage laser system that includes a master oscillator (MO) 567 that provides a seed light beam 542 to a power amplifier (PA) 568. The MO 567 and the PA 568 may be considered to be subsystems of the light source 560 or systems that are part of the light source 560. The PA 568 receives the seed light beam 542 from the MO 567 and amplifies the seed light beam 542 to generate the light beam 541 for use in the lithography exposure apparatus 569. For example, in some implementations, the MO 567 may emit a pulsed seed light beam, with seed pulse energies of approximately 1 milliJoule (mJ) per pulse, and these seed pulses may be amplified by the PA 568 to about 10 to 15 mJ.

The MO 567 includes a discharge chamber 565_1 having two elongated electrodes 562a_1 and 562b_1, a gain medium 561_1 that is a gas mixture, and a fan (not shown) for circulating the gas mixture between the electrodes 562a_1, 562b_1. A resonator is formed between a line narrowing module 586 on one side of the discharge chamber 565_1 and an output coupler 581 on a second side of the discharge chamber 565_1.

The discharge chamber 565_1 includes a first chamber window 563_1 and a second chamber window 564_1. The first and second chamber windows 563_1 and 564_1 are on opposite sides of the discharge chamber 565_1. The first and second chamber windows 563_1 and 564_1 transmit light in the DUV range and allow DUV light to enter and exit the discharge chamber 565_1.

The line narrowing module 586 may include a diffractive optic such as a grating that finely tunes the spectral output of the discharge chamber 565_1. The light source 560 also includes a line center analysis module 584 that receives an output light beam from the output coupler 581 and a beam coupling optical system 583. The line center analysis module 584 is a measurement system that may be used to measure or monitor the wavelength of the seed light beam 542. The line center analysis module 584 may be placed at other locations in the light source 560, or it may be placed at the output of the light source 560.

The gas mixture that is the gain medium 561_1 may be any gas suitable for producing a light beam at the wavelength and bandwidth required for the application. For an excimer source, the gas mixture 561_1 may contain a noble gas (rare gas) such as, for example, argon or krypton, a halogen, such as, for example, fluorine or chlorine and traces of xenon apart from a buffer gas, such as helium. Specific examples of the gas mixture include argon fluoride (ArF), which emits light at a wavelength of about 193 nm, krypton fluoride (KrF), which emits light at a wavelength of about 248 nm, or xenon chloride (XeCl), which emits light at a wavelength of about 351 nm. Thus, the light beams 541 and 542 include wavelengths in the DUV range in this implementation. The excimer gain medium (the gas mixture) is pumped with short (for example, nanosecond) current pulses in a high-voltage electric discharge by application of a voltage to the elongated electrodes 562a_1, 562b_1.

The PA 568 includes a beam coupling optical system 583 that receives the seed light beam 542 from the MO 567 and directs the seed light beam 542 through a discharge chamber 565_2, and to a beam turning optical element 582, which modifies or changes the direction of the seed light beam 542 so that it is sent back into the discharge chamber 565_2. The beam turning optical element 582 and the beam coupling optical system 583 form a circulating and closed loop optical path in which the input into a ring amplifier intersects the output of the ring amplifier at the beam coupling optical system 583.

The discharge chamber 565_2 includes a pair of elongated electrodes 562a_2, 562b_2, a gain medium 561_2, and a fan (not shown) for circulating the gain medium 561_2 between the electrodes 562a_2, 562b_2. The gas mixture that forms the gain medium 561_2 may be the same as the gas mixture that forms gain medium 561_1.

The discharge chamber 565_2 includes a first chamber window 563_2 and a second chamber window 564_2. The first and second chamber windows 563_2 and 564_2 are on opposite sides of the discharge chamber 565_2. The first and second chamber windows 563_2 and 564_2 transmit light in the DUV range and allow DUV light to enter and exit the discharge chamber 565_2.

The output light beam 541 is directed through a beam preparation system 585 prior to reaching the lithography exposure apparatus 469. The beam preparation system 585 may include a bandwidth analysis module that measures various parameters (such as the bandwidth or the wavelength) of the beam 541. The beam preparation system 585 also includes the pulse stretcher 310, which stretches each pulse of the output light beam 541 in time. The beam preparation system 585 also may include other components that are able to act upon the beam 541 such as, for example, reflective and/or refractive optical elements (such as, for example, lenses and mirrors), filters, and optical apertures (including automated shutters).

The DUV light source 560 also includes a gas management system 579, which is in fluid communication with an interior 578 of the DUV light source 560. As discussed above, the gas management system 579 provides the purge gas 412 to the interior 578. In the example of FIG. 5, the purge gas 412 surrounds the chambers 565_1 and 565_2 and also surrounds optical components of some of the subsystems of the DUV light source 560. For example, the purge gas 412 surrounds the optical components in the line narrowing module 586, output coupler 581, the line center analysis module 584, the beam coupling optical system 583, and the beam turning optical element 582. Although the purge gas 412 is in the interior 578 and surrounds the discharge chambers 565_1 and 565_2 and various other optical components, the purge gas 412 does not penetrate the discharge chambers 565_1 and 565_2 and does not disturb or change the chemical composition of the gain mediums 561_1 and 561_2.

The photolithography system 550 also includes the control system 280. The control system 280 controls the cavity length of the pulse stretcher 310 as discussed above. The control system 280 is coupled to the lithography exposure apparatus 569 and may receive the data 232 from the lithography exposure apparatus 569 or from the sensor 230 (which is not shown in FIG. 5).

The lithography exposure apparatus 569 also may include, for example, temperature control devices (such as air conditioning devices and/or heating devices), and/or power supplies for the various electrical components. The control system 580 also may control these components. In some implementations, the control system 580 is implemented to include more than one sub-control system, with at least one sub-control system (a lithography controller) dedicated to controlling aspects of the lithography exposure apparatus 569. In these implementations, the control system 580 may be used to control aspects of the lithography exposure apparatus 469 instead of, or in addition to, using the lithography controller.

When the gain medium 561_1 or 561_2 is pumped by applying voltage to the electrodes 562a_1, 562b_1 or 562a_2, 562b_2, respectively, the gain medium 561_1 and/or 561_2 emits light. When voltage is applied to the electrodes at regular temporal intervals, the light beam 541 is pulsed. Thus, the repetition rate of the pulsed light beam 541 is determined by the rate at which voltage is applied to the electrodes. The repetition rate of the pulses may range between about 500 and 6,000 Hz for various applications. In some implementations, the repetition rate may be greater than 6,000 Hz, and may be, for example, 12,000 Hz or greater, but other repetition rates may be used in other implementations.

The embodiments can be further described using the following clauses:
1. A system comprising:
an optical pulse stretcher comprising:
a first reflective optical element;
a second reflective optical element; and
an optical coupling system, wherein a distance between the first reflective optical element and the second reflective optical element defines a separation distance in an optical cavity, and the optical coupling system is configured to bring pulses of light into the cavity and to allow pulses of light to exit the cavity;
an actuation system configured to control the separation distance;
a sensor configured to produce data related to at least two pulses of light that exit the cavity; and
a control system coupled to the actuation system, wherein the control system is configured to control the actuation system and the separation distance based on the data.
2. The system of clause 1, wherein the control system is further configured to:
analyze additional data from the sensor after controlling the actuation system; and
determine whether to control the actuation system again based on the analyzed additional data.
3. The system of clause 1, wherein the control system is configured to identify at least two pulses of light in the data, and to determine a position of the identified pulses of light in the data; and the control system controls the actuation system and the separation distance based on the determined positions.
4. The system of clause 3, wherein the sensor comprises a two-dimensional imaging sensor, and the data from the imaging sensor comprises a two-dimensional image.
5. The system of clause 4, wherein determining a position of the identified pulses of light in the data comprises determining a spatial separation between at least two pulses of light identified in the data, and the control system controls the actuation system and the separation distance based on the determined spatial separation.
6. The system of clause 5, wherein the control system controls the actuation system and the separation distance by moving one or more of the first reflective optical element and the second optical element.
7. The system of clause 6, wherein the control system is further configured to determine a direction to move the one or more of the first reflective optical element and the second reflective optical element based on the determined spatial separation.
8. The system of clause 7, wherein the control system is further configured to determine an amount to move the one or more of the first reflective optical element and the second reflective optical element based on the determined spatial separation.
9. The system of clause 5, wherein the determined spatial separation comprises a first determined spatial separation, and the control system is further configured to:
analyze additional data from the sensor after controlling the actuation system;
identify at least one additional pulse of light in the additional data;
determine a second spatial separation, the second spatial separation being a spatial separation between the at least one additional identified pulse of light and at least one other pulse of light; compare the first spatial separation and the second spatial separation; and determine whether to control the actuation system again based on the comparison.
10. The system of clause 9, wherein the control system only controls the actuation system again if the second spatial separation is a threshold value greater than the first spatial separation.
11. The system of clause 5, wherein the spatial separation is between a center of each of at least two pulses of light identified in the data.
12. The system of clause 1, wherein the first reflective optical element comprises a first curved reflective surface; and the second reflective optical element comprises a second curved reflective surface.
13. The system of clause 12, wherein the separation distance is the distance between a center of the first curved reflective surface and a center of the second curved reflective surface.
14. The system of clause 1, wherein the optical coupling system comprises a beam splitter that is separate and distinct from the first reflective optical element and the second reflective optical element.
15. The system of clause 1, wherein the actuation system comprises:
a first actuation module coupled to the first reflective optical element, the first activation module configured to move the first reflective optical element based on a command from the control system; and
a second actuation module coupled to the second reflective optical element, the second activation module configured to move the second reflective optical element based on a command from the control system; and
the control system is configured to control the actuation system by commanding one or more of the first actuation module and the second actuation module.
16. The system of clause 1, wherein the cavity lacks a gain medium.
17. A system comprising:
an optical assembly comprising:
a first optical element comprising a first curved optical surface; and
a second optical element comprising a second curved optical surface, wherein the first curved optical and the second curved optical surface define at least a portion of an optical cavity;
a sensor configured to produce data related to at least two pulses of light that exit the cavity; and
a control system configured to control a position of one or more of the first optical element and the second optical element based on data from the sensor to thereby compensate for changes in a radius of curvature of one or more of the first curved optical surface and the second curved optical surface.
18. The system of clause 17, wherein the data comprises information related to a location of at least two pulses of light that exit the cavity.
19. The system of clause 17, wherein the data comprises information related to a divergence of at least two pulses of light that exit the cavity.
20. The system of clause 17, further comprising an actuation system coupled to one or more of the first optical element and the second optical element.
21. The system of clause 17, wherein the first curved surface is a first curved reflective surface having a first nominal radius of curvature, and the second curved surface is a second curved surface having a second nominal radius of curvature.
22. The system of clause 21, wherein the cavity comprises a confocal cavity.
23. The system of clause 17, wherein a distance between the first curved reflective surface and the second curved reflective surface defines a length of the cavity, and the control system is configured to compensate for changes in the radius of curvature of one or more of the first curved optical surface and the second curved optical surface by adjusting the length of the cavity.
24. The system of clause 17, wherein the optical assembly comprises a pulse stretcher.
25. The system of clause 17, wherein pulses of light exit the cavity through one of the first optical element and the second optical element.
26. The system of clause 17, wherein pulses of light exit the cavity through an optical element that is separate and distinct from the first optical element and the second optical element.
27. A control system configured for use with an optical pulse stretcher, the control system comprising: a data analysis module configured to:
analyze data from a sensor, wherein the sensor is configured to sense at least a portion of two or more pulses of light that exit an optical cavity at different times, and wherein, to analyze the data, the data analysis module is configured to: determine one or more properties of at least two of the pulses of light based on the data from the sensor; and
the control system further comprises an actuation control module configured to:
determine a command signal for an actuation system coupled to the optical cavity based on the one or more properties; and
provide the command signal to the actuation system to adjust a length of the optical cavity.
28. The control system of clause 27, wherein the determined one or more properties comprises a location of each of the at least two pulses of light in a plane perpendicular to a direction of propagation of the pulse of light.
29. The control system of clause 28, wherein the determined one or more properties comprises a divergence of each of the at least two pulses of light in a plane perpendicular to a direction of propagation of the pulse of light.
30. An optical system comprising:
an optical oscillator configured to emit an amplified pulsed light beam on a beam path;
a pulse stretcher configured to be placed on the beam path, the pulse stretcher comprising:
a first optical element comprising a first curved optical surface; and
a second optical element comprising a second curved optical surface, wherein the first curved optical and the second curved optical surface define a cavity;
a sensor configured to produce data related to at least two pulses of the amplified pulsed light beam that exit the cavity; and
a control system configured to control a position of one or more of the first optical element and the second optical element based on data from the sensor to thereby compensate for changes in a radius of curvature of one or more of the first curved optical surface and the second curved optical surface.
31. The optical system of clause 30, wherein the optical oscillator is a deep ultraviolet (DUV) optical oscillator that is configured to emit an amplified light beam having one or more DUV wavelengths.

Still other implementations are within the scope of the following claims.

1. A system comprising:
an optical pulse stretcher comprising:
a first reflective optical element;
a second reflective optical element; and
an optical coupling system, wherein a distance between the first reflective optical element and the second reflective optical element defines a separation distance in an optical cavity, and the optical coupling system is configured to bring pulses of light into the cavity and to allow pulses of light to exit the cavity;
an actuation system configured to control the separation distance;
a sensor configured to produce data related to at least two pulses of light that exit the cavity; and
a control system coupled to the actuation system, wherein the control system is configured to control the actuation system and the separation distance based on the data.

2. The system of claim 1, wherein the control system is further configured to:
analyze additional data from the sensor after controlling the actuation system; and
determine whether to control the actuation system again based on the analyzed additional data.

3. The system of claim 1, wherein the control system is configured to identify at least two pulses of light in the data, and to determine a position of the identified pulses of light in the data; and
the control system controls the actuation system and the separation distance based on the determined positions.

4. The system of claim 3, wherein the sensor comprises a two-dimensional imaging sensor, and the data from the imaging sensor comprises a two-dimensional image.

5. The system of claim 4, wherein determining a position of the identified pulses of light in the data comprises determining a spatial separation between at least two pulses of light identified in the data, and the control system controls the actuation system and the separation distance based on the determined spatial separation.

6. The system of claim 5, wherein the control system controls the actuation system and the separation distance by moving one or more of the first reflective optical element and the second optical element.

7. The system of claim 6, wherein the control system is further configured to determine a direction to move the one or more of the first reflective optical element and the second reflective optical element based on the determined spatial separation.

8. The system of claim 7, wherein the control system is further configured to determine an amount to move the one or more of the first reflective optical element and the second reflective optical element based on the determined spatial separation.

9. The system of claim 5, wherein the determined spatial separation comprises a first determined spatial separation, and the control system is further configured to:
analyze additional data from the sensor after controlling the actuation system;
identify at least one additional pulse of light in the additional data;
determine a second spatial separation, the second spatial separation being a spatial separation between the at least one additional identified pulse of light and at least one other pulse of light;
compare the first spatial separation and the second spatial separation; and
determine whether to control the actuation system again based on the comparison.

10. The system of claim 9, wherein the control system only controls the actuation system again if the second spatial separation is a threshold value greater than the first spatial separation.

11. The system of claim 5, wherein the spatial separation is between a center of each of at least two pulses of light identified in the data.

12. The system of claim 1, wherein the first reflective optical element comprises a first curved reflective surface; and the second reflective optical element comprises a second curved reflective surface.

13. The system of claim 12, wherein the separation distance is the distance between a center of the first curved reflective surface and a center of the second curved reflective surface.

14. The system of claim 1, wherein the optical coupling system comprises a beam splitter that is separate and distinct from the first reflective optical element and the second reflective optical element.

15. The system of claim 1, wherein the actuation system comprises:
a first actuation module coupled to the first reflective optical element, the first activation module configured to move the first reflective optical element based on a command from the control system; and
a second actuation module coupled to the second reflective optical element, the second activation module configured to move the second reflective optical element based on a command from the control system; and
the control system is configured to control the actuation system by commanding one or more of the first actuation module and the second actuation module.

16. The system of claim 1, wherein the cavity lacks a gain medium.

17. A system comprising:
an optical assembly comprising:
a first optical element comprising a first curved optical surface; and
a second optical element comprising a second curved optical surface, wherein the first curved optical and the second curved optical surface define at least a portion of an optical cavity;
a sensor configured to produce data related to at least two pulses of light that exit the cavity; and
a control system configured to control a position of one or more of the first optical element and the second optical element based on data from the sensor to thereby compensate for changes in a radius of curvature of one or more of the first curved optical surface and the second curved optical surface.

18. The system of claim 17, wherein the data comprises information related to a location of at least two pulses of light that exit the cavity.

19. The system of claim 17, wherein the data comprises information related to a divergence of at least two pulses of light that exit the cavity.

20. The system of claim 17, further comprising an actuation system coupled to one or more of the first optical element and the second optical element.

21. The system of claim 17, wherein the first curved surface is a first curved reflective surface having a first nominal radius of curvature, and the second curved surface is a second curved surface having a second nominal radius of curvature.

22. The system of claim 21, wherein the cavity comprises a confocal cavity.

23. The system of claim 17, wherein a distance between the first curved reflective surface and the second curved reflective surface defines a length of the cavity, and the control system is configured to compensate for changes in the radius of curvature of one or more of the first curved optical surface and the second curved optical surface by adjusting the length of the cavity.

24. The system of claim 17, wherein the optical assembly comprises a pulse stretcher.

25. The system of claim 17, wherein pulses of light exit the cavity through one of the first optical element and the second optical element.

26. The system of claim 17, wherein pulses of light exit the cavity through an optical element that is separate and distinct from the first optical element and the second optical element.

27. A control system configured for use with an optical pulse stretcher, the control system comprising:
a data analysis module configured to:
analyze data from a sensor, wherein the sensor is configured to sense at least a portion of two or more pulses of light that exit an optical cavity at different times, and wherein, to analyze the data, the data analysis module is configured to: determine one or more properties of at least two of the pulses of light based on the data from the sensor; and
the control system further comprises an actuation control module configured to:
determine a command signal for an actuation system coupled to the optical cavity based on the one or more properties; and
provide the command signal to the actuation system to adjust a length of the optical cavity.

28. The control system of claim 27, wherein the determined one or more properties comprises a location of each of the at least two pulses of light in a plane perpendicular to a direction of propagation of the pulse of light.

29. The control system of claim 28, wherein the determined one or more properties comprises a divergence of each of the at least two pulses of light in a plane perpendicular to a direction of propagation of the pulse of light.

30. An optical system comprising:
an optical oscillator configured to emit an amplified pulsed light beam on a beam path;
a pulse stretcher configured to be placed on the beam path, the pulse stretcher comprising:
a first optical element comprising a first curved optical surface; and
a second optical element comprising a second curved optical surface, wherein the first curved optical and the second curved optical surface define a cavity;
a sensor configured to produce data related to at least two pulses of the amplified pulsed light beam that exit the cavity; and
a control system configured to control a position of one or more of the first optical element and the second optical element based on data from the sensor to thereby compensate for changes in a radius of curvature of one or more of the first curved optical surface and the second curved optical surface.

31. The optical system of claim 30, wherein the optical oscillator is a deep ultraviolet (DUV) optical oscillator that is configured to emit an amplified light beam having one or more DUV wavelengths.
